(19) United States
(12) Patent Application Publication
(10) Pub. No.: US 2023/0156594 A1
(43) Pub. Date: May 18, 2023

(54) METHOD AND APPARATUS FOR CONFIGURING RRC STATE, COMMUNICATION DEVICE, AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 17/916,385

(22) PCT Filed: Apr. 4, 2020
(86) PCT No.: PCT/CN2020/083391

§ 371 Date: Sep. 30, 2022

(51) Int. Cl. H04W 52/02

(52) U.S. Cl. CPC H04W 52/0212

(57) ABSTRACT

A method for configuring a radio resource control (RRC) state, performed by a user equipment and: setting, by the user equipment, a radio resource control state as Up-Link only RRC_INACTIVE according to configuration by a network device.

### CROSS-REFERENCE TO RELATED APPLICATION

The present application is a U.S. National Phase Application of International Patent Application Serial No. PCT/CN2020/083391 filed on Apr. 4, 2020. The entire contents of the above-cited application are hereby incorporated by reference in their entirety for all purposes.

### BACKGROUND

User equipment (UE) may monitor a paging message from a network device. Upon monitoring the paging message, the UE receives downlink data sent by the network device.

### SUMMARY

According to examples of the disclosure, there is provided a method and apparatus for configuring radio resource control (RRC) state, a communication device and a storage medium. The technical solution is as follows.

According to one aspect of the disclosure, there is provided a method for configuring RRC state, including: setting, by a user equipment, a radio resource control (RRC) state as Up-Link only RRC_INACTIVE according to configuration by a network device.

According to another aspect of the disclosure, there is provided a method for configuring RRC state, including: configuring, by a network device, a user equipment to set an RRC state as Up-Link only RRC_INACTIVE.

According to one aspect of the disclosure, there is provided an apparatus for configuring RRC state, including: a sending module, configured to set an RRC state as Up-Link only RRC_INACTIVE according to configuration by a network device.

According to another aspect of the disclosure, there is provided an apparatus for configuring RRC state, including: a processing module, configured to set, by a user equipment, an RRC state as Up-Link only RRC_INACTIVE.

According to another aspect of the disclosure, there is provided a user equipment, including: a processor; a transceiver connected with the processor; and a memory configured to store an executable signaling of the processor. Where the processor is configured to load and execute the executable signaling to implement the steps on a user equipment side in the method for configuring RRC state described in the above aspects.

According to another aspect of the disclosure, there is provided a network device, including: a processor; a transceiver connected with the processor; and a memory configured to store an executable signaling executed by the processor. Where the processor is configured to load and execute the executable signaling to implement the steps on a network device side in the method for configuring RRC state described in the above aspects.

According to another aspect of the disclosure, there is further provided a non-transitory computer-readable storage medium storing an executable signaling, and the executable signaling is loaded and executed by a processor to implement the method for configuring RRC state described in the above aspects.

According to another aspect of the disclosure, there is provided a computer program product storing an executable signaling, and the executable signaling is loaded and executed by a processor to implement the method for configuring RRC state described in the above aspects.

According to another aspect of the disclosure, there is provided a communication chip, the communication chip includes a programmable logic circuit and/or program instructions, and the chip is configured to implement the method for configuring RRC state described in the above aspects.

### BRIEF DESCRIPTION OF THE DRAWINGS

In order to illustrate the technical solutions in examples of the disclosure more clearly, the drawings used in the description of the examples will be briefly introduced. It should be understood that the drawings in the following description are only some examples of the disclosure, and those ordinarily skilled in the art can obtain other drawings according to these drawings without creative effort.

FIG. 1 is a block diagram of a communication system according to an example of the disclosure.

FIG. 2 is a flow diagram of a method for configuring RRC state according to an example of the disclosure.

FIG. 3 is a flow diagram of a method for configuring RRC state according to an example of the disclosure.

FIG. 4 is a flow diagram of a method for configuring RRC state according to an example of the disclosure.

FIG. 5 is a flow diagram of a method for configuring RRC state according to an example of the disclosure.

FIG. 6 is a flow diagram of a method for configuring RRC state according to an example of the disclosure.

FIG. 7 is a flow diagram of a method for configuring RRC state according to an example of the disclosure.

FIG. 8 is a flow diagram of a method for configuring RRC state according to an example of the disclosure.

FIG. 9 is a flow diagram of a method for configuring RRC state according to an example of the disclosure.

FIG. 10 is a flow diagram of a method for configuring RRC state according to an example of the disclosure.

FIG. 11 is a flow diagram of a method for configuring RRC state according to an example of the disclosure.

FIG. 12 is a flow diagram of a method for configuring RRC state according to an example of the disclosure.

FIG. 13 is a flow diagram of a method for configuring RRC state according to an example of the disclosure.

FIG. 14 is a flow diagram of a method for configuring RRC state according to an example of the disclosure.

FIG. 15 is a flow diagram of a method for configuring RRC state according to an example of the disclosure.

FIG. 16 is a block diagram of an apparatus for configuring RRC state according to an example of the disclosure.

FIG. 17 is a block diagram of an apparatus for configuring RRC state according to another example of the disclosure.

FIG. 18 is a block diagram of a communication device according to an example of the disclosure.

### DETAILED DESCRIPTION

In order to make the objects, technical solutions and advantages of the disclosure clearer, the implementation of the disclosure will be further described in detail below in combination with the accompanying drawings.

First of all, some terms involved in the disclosure are briefly introduced.

RRC state: three RRC states are included in a new radio (NR) system, that is, an RRC active state (RRC_ACTIVE), an RRC inactive state (RRC_INACTIVE) and an RRC idle state (RRC_IDLE). These three RRC states may be referred to as an active state, an inactive state and an idle state for short.

Inactive state: a new RRC state introduced in NR. It is also referred to here as a normal inactive state. The normal inactive state has the following typical features: connection with core network is maintained; a RAN stores a context of UE; the network needs to know the position of the UE, which is achieved by the UE reporting periodic RNAU or by the UE reporting that the RNAU is updated; the RAN may trigger a paging message of the UE; and there are no dedicated resources.

Among NR-Lite features in the related art, a new type of terminal is introduced, which is designed to cope with scenarios except Enhanced Mobile Broadband (eMBB), Ultra-reliable and Low Latency Communications (URLLC) and Massive Machine Type Communication (mMTC). That is, the rate, delay, and reliability requested by the new type of terminal are not covered by the above scenarios. For example, the rate is lower than the rate requested by the eMBB but is higher than the rate requested by the mMTC, and the requirements for the delay and the reliability are more relaxed than the requirements for the delay and the reliability requested by the URLLC.

Three typical application scenarios for the new type of terminal include factory sensors, video surveillance, and wearable devices. Therefore, it may be considered that this feature introduces a light terminal. This type of terminal has the following features: the quantity of receiving (RX) antennas is reduced from the conventional 4 to 2 or 1; the bandwidth is reduced, a typical value is 5 MHz/10 MHz when operating in an FR1 frequency band, and a typical value is 40 MHz when operating in an FR2 frequency band; the processing capacity of the UE is reduced, and may support smaller transport blocks TBsize and DCI size; and the mobility is lower.

Therefore, the inactive state is an operating mode more suitable for the above type of terminal, such as Internet of Things devices. But for many Internet of Things devices, there are usually some special requirements. For example, some Internet of Things devices only have the requirements for uplink transmission and do not need an independent downlink mode. That is, transmission of downlink data only needs to follow uplink transmission. Therefore, the operating mode of the Internet of Things devices operating in the inactive state needs to be optimized.

According to an example of the disclosure, there is proposed a new RRC state, that is, Up-Link only RRC_INACTIVE. When in the inactive state for an uplink mode, the UE does not need to monitor a paging message from a network device, which can save power consumption.

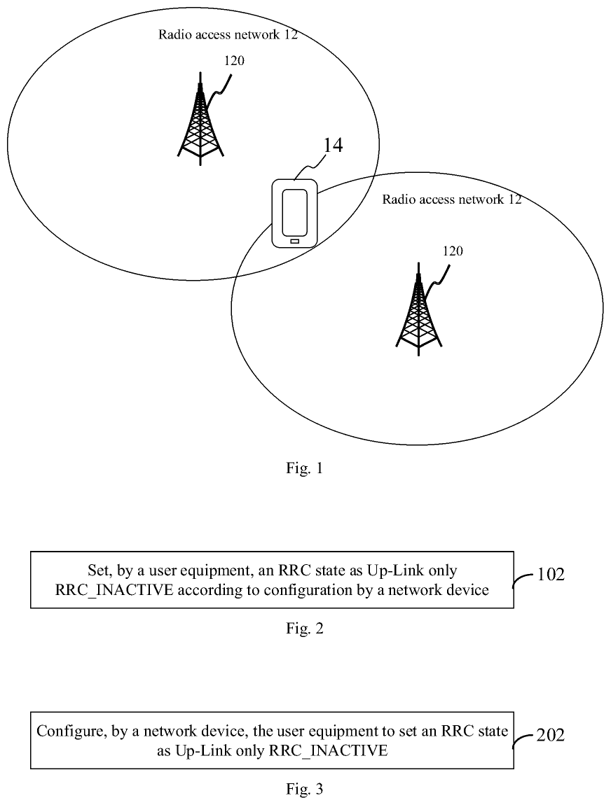

FIG. 1 shows a block diagram of a communication system according to an example of the disclosure. The communication system may include a radio access network (RAN) 12 and a user equipment 14.

The radio access network 12 includes more than one network device 120. The network device 120 may be base station, which is an apparatus deployed in the access network to be configured to provide a wireless communication function for the user equipment. The base station may include various forms of macro base stations, micro base stations, relay stations, access points and so on. In systems using different radio access technologies, the names of devices with the functions of the base station may vary. For example, in LTE system, the device is called eNodeB or eNB. In 5G NR system, the device is called gNodeB or gNB. With the evolution of communication technology, the description of “base station” may change. For the convenience of description in the examples of the disclosure, the above-mentioned apparatus for providing the wireless communication function for the user equipment 14 is collectively referred to as network device.

The user equipment 14 may include various kinds of handheld devices, vehicle-mounted devices, wearable devices, computing devices, or other processing devices connected to wireless modems with wireless communication functions, as well as various forms of user devices, mobile stations (MSs), terminal devices and so on. For the convenience of description, the above-mentioned devices are collectively referred to as user equipment. The network device 120 and the user equipment 14 communicate with each other through a certain air interface technology, such as a Uu interface.

The technical solutions of the examples of the disclosure can be applied to various communication systems, such as Global System of Mobile Communication (GSM) systems, Code Division Multiple Access (CDMA) systems, Wideband Code Division Multiple Access (WCDMA) systems, General Packet Radio Service (GPRS), Long Term Evolution (LTE) systems, LTE Frequency Division Duplex (FDD) systems, LTE Time Division Duplex (TDD) systems, Advanced Long Term Evolution (LTE-A) systems, New Radio (NR) systems, evolved systems of NR systems, LTE-based access to Unlicensed spectrum (LTE-U) systems, NR-U systems, Universal Mobile Telecommunication Systems (UMTS), Worldwide Interoperability for Microwave Access (WiMAX) communication systems, Wireless Local Area Networks (WLAN), Wireless Fidelity (WiFi), next-generation communication systems or other communication systems.

Traditional communication system generally supports a limited quantity of connections and are easy to implement. However, with the development of the communication technology, mobile communication system will not only support traditional communication, but also support, for example, Device to Device (D2D) communication, Machine to Machine (M2M) communication, Machine Type Communication (MTC), Vehicle to Vehicle (V2V) communication and Vehicle to Everything (V2X) system, etc. The examples of the disclosure can also be applied to these communication systems.

User equipment (UE) may monitor a paging message from a network device. Upon monitoring the paging message, the UE receives downlink data sent by the network device. For some situations or some terminals, the above process may have a problem of large power consumption.

FIG. 2 shows a flow diagram of a method for configuring RRC state according to an example of the disclosure. The example is illustrated by applying the method to the UE shown in FIG. 1, and the UE may be normal UE or NR-Lite UE. The method includes Step 102, setting an RRC state as Up-Link only RRC_INACTIVE by a user equipment according to configuration by a network device.

The Up-Link only RRC_INACTIVE may be understood as an RRC state without an independent downlink mode. Or the Up-Link only RRC_INACTIVE may also be understood as an RRC state in which downlink transmission always follows uplink transmission. Or the Up-Link only RRC_INACTIVE may further be understood as an RRC state that does not need to monitor a paging message. Or the Up-Link only RRC_INACTIVE may also be understood as an RRC state in which the network device will cache downlink data (including the paging message) of the user equipment and send the downlink data after the user equipment performs the uplink transmission.

The Up-Link only RRC_INACTIVE includes but is not limited to at least one of the following features. Feature 1: it is a sub-state of a normal inactive state (which may be referred to as an inactive state for short). Feature 2: it is a state operating independently of the normal inactive state. Feature 3: the downlink transmission follows the uplink transmission. And Feature 4: RAN Notification Area Update (RNAU) is canceled or is not used.

It should be noted that the Up-Link only RRC_INACTIVE is a schematic name of the newly added inactive state (or the new RRC state) proposed in the disclosure. The Up-Link only RRC_INACTIVE may also have other names with equivalent meanings, such as Up-Link priority RRC_INACTIVE, or up-link-mode inactive state, or up-link-mode only inactive state, or Up-Link priority RRC_INACTIVE etc. The disclosure does not limit the name of the Up-Link only RRC_INACTIVE.

To sum up, according to the method provided by the example, the user equipment sets the RRC state as the Up-Link only RRC_INACTIVE, and the user equipment does not need to monitor the paging message from the network device under the state of the Up-Link only RRC_INACTIVE, thus the power consumption of the user equipment is effectively reduced.

FIG. 3 shows a flow diagram of a method for configuring RRC state according to an example of the disclosure. The example is illustrated by applying the method to the network device shown in FIG. 1. The method includes Step 202: configuring the user equipment to set the RRC state as the Up-Link only RRC_INACTIVE by the network device.

The Up-Link only RRC_INACTIVE may be understood as an RRC state without an independent downlink mode. Or the Up-Link only RRC_INACTIVE may also be understood as an RRC state in which downlink transmission always follows uplink transmission. Or the Up-Link only RRC_INACTIVE may further be understood as an RRC state that does not need to monitor a paging message. Or the Up-Link only RRC_INACTIVE may also be understood as an RRC state in which the network device will cache downlink data (including the paging message) of the user equipment and send the downlink data after the user equipment performs the uplink transmission.

The Up-Link only RRC_INACTIVE includes but is not limited to at least one of the following features. Feature 1: it is a sub-state of a normal inactive state. Feature 2: it is a state operating independently of the normal inactive state. Feature 3: the downlink transmission follows the uplink transmission. And Feature 4: RAN Notification Area Update (RNAU) is canceled or is not used.

To sum up, according to the method provided by the example, the user equipment is configured to set the RRC state as the Up-Link only RRC_INACTIVE, and the user equipment does not need to monitor the paging message from the network device under the state of the Up-Link only RRC_INACTIVE, thus the power consumption of the user equipment is effectively reduced.

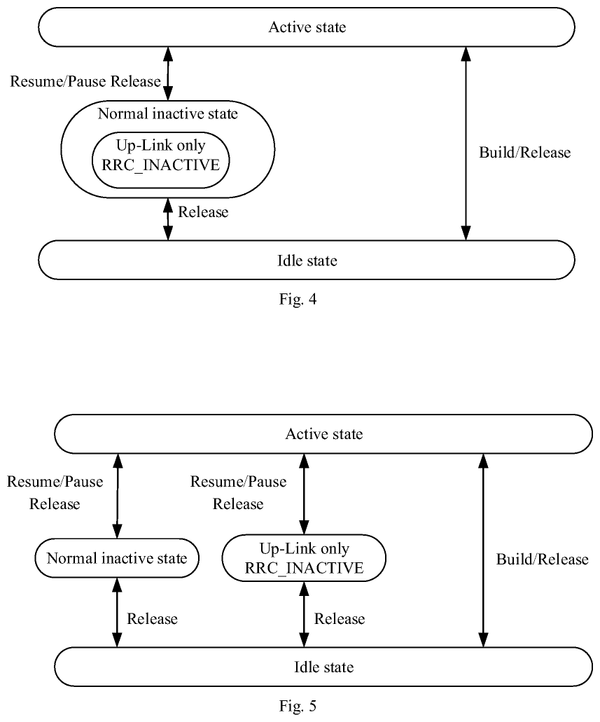

In the alternative examples based on FIG. 2 or FIG. 3, the Up-Link only RRC_INACTIVE is an RRC sub-state of the normal inactive state, and it is possible to switch to the Up-Link only RRC_INACTIVE only after switching to the normal inactive state. As shown in FIG. 4, an RRC state machine inside the user equipment includes an active state, an idle state, a normal inactive state, and Up-Link only RRC_INACTIVE. For example, the user equipment has only one RRC state in the NR at a time.

In the RRC state machine shown in FIG. 4, the network device configures the UE to switch between the Up-Link only RRC_INACTIVE and the normal inactive state based on the type of the UE or the capability of the UE or the expectation of the UE.

For example, in the case of switching from the active state to the Up-Link only RRC_INACTIVE: the network device instructs the UE to enter the normal inactive state first by an RRC connection release message; after that, the network device notifies the UE to switch between the Up-Link only RRC_INACTIVE and the normal inactive state through Downlink Control Information (DCI) or Medium Access Control Control Element (MAC CE). Further, or in the alternative, the UE may directly switch from the Up-Link only RRC_INACTIVE to the active state in response to the UE initiating a resume request to the network device. Even further, or in the alternative, the UE may directly switch from the Up-Link only RRC_INACTIVE to the idle state in response to the network device sending the RRC connection release message to the UE to instruct the UE to enter the idle state.

In the alternative examples based on FIG. 2 or FIG. 3, the Up-Link only RRC_INACTIVE is an RRC state operating independently of the normal inactive state. As shown in FIG. 5, an RRC state machine inside the user equipment includes an active state, an idle state, an inactive state, and Up-Link only RRC_INACTIVE. For example, the user equipment has only one RRC state in the NR at a time.

In the RRC state machine shown in FIG. 5, the network device configures the UE to switch from the active state to the Up-Link only RRC_INACTIVE or the normal inactive state based on the type of the UE or the capability of the UE or the expectation of the UE. For example, in the case of switching from the active state to the Up-Link only RRC_INACTIVE: the network device instructs the UE to switch from the active state to the Up-Link only RRC_INACTIVE by an RRC connection release message. Further, or in the alternative, the UE may directly switch from the Up-Link only RRC_INACTIVE to the active state in response to the UE initiating a resume request to the network device. Furthermore, or in the alternative, the UE may directly switch from the Up-Link only RRC_INACTIVE to the idle state in response to the network device sending an RRC connection release message to the UE to instruct the UE to enter the idle state.

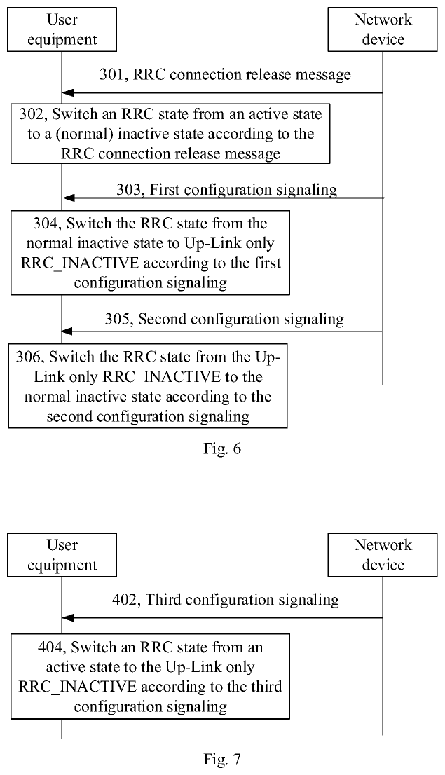

In the alternative examples based on FIG. 4, the Up-Link only RRC_INACTIVE is an RRC sub-state of the normal inactive state. As shown in FIG. 6, the method includes steps 301-306.

Step 301 includes sending the RRC connection release message to the user equipment by the network device. It is assumed that an initial RRC state of the user equipment is the active state.

Step 302 includes receiving, by the user equipment, the RRC connection release message sent by the network device, and switching the RRC state from the active state to the normal inactive state by the user equipment according to the RRC connection release message.

Step 303 includes sending a first configuration signaling to the user equipment by the network device.

In an example, the first configuration signaling includes an RRC message, a MAC CE or an DCI.

Step 304 includes receiving, by the user equipment, the first configuration signaling sent by the network device, and switching the RRC state from the normal inactive state to the Up-Link only RRC_INACTIVE by the user equipment according to the first configuration signaling.

Step 305 includes sending a second configuration signaling to the user equipment by the network device.

In an example, the second configuration signaling includes an RRC message, a MAC CE or an DCI.

Finally, Step 306 includes receiving, by the user equipment, the second configuration signaling sent by the network device, and switching the RRC state from the normal inactive state to the Up-Link only RRC_INACTIVE by the user equipment according to the second configuration signaling.

To sum up, according to the method provided by the example, by designing the Up-Link only RRC_INACTIVE to be the RRC sub-state of the normal inactive state, changes to existing protocols can be minimized, and the compatibility of technical solutions can be improved.

In the alternative examples based on FIG. 5, the Up-Link only RRC_INACTIVE is an RRC state operating independently of the normal inactive state. As shown in FIG. 7, the method includes the following steps 402 and 404.

Step 402 includes sending a third configuration signaling to the user equipment by the network device.

It is assumed that an initial RRC state of the user equipment is the active state.

In an example, the third configuration signaling includes the RRC connection release message.

Step 404 includes receiving, by the user equipment, the third configuration signaling sent by the network device, and switching the RRC state from the active state to the Up-Link only RRC_INACTIVE by the user equipment according to the third configuration signaling.

To sum up, according to the method provided by the example, by designing the Up-Link only RRC_INACTIVE to be the RRC sub-state operating independently of the normal inactive state, less changes can be made to the normal terminal, and changes to existing protocols are made for the new type of terminal, and the compatibility of technical solutions are improved.

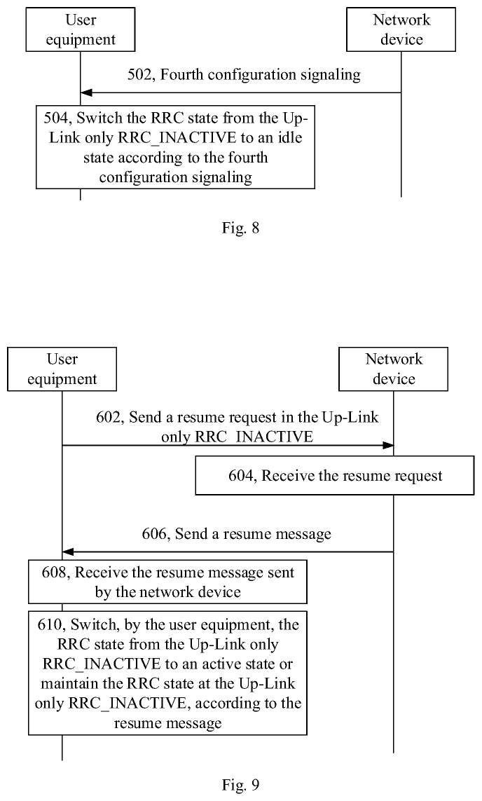

In the alternative examples based on FIG. 4 or FIG. 5, as shown in FIG. 8, the method further includes the following steps 502 and 504.

Step 502 includes sending a fourth configuration signaling to the user equipment by the network device.

In an example, the fourth configuration signaling includes the RRC connection release message.

Step 504, receiving, by the user equipment, the fourth configuration signaling sent by the network device, and switching the RRC state from the Up-Link only RRC_INACTIVE to the idle state according to the fourth configuration signaling.

To sum up, according to the method provided by the example, by designing the fourth configuration signaling to be the RRC connection release message, changes to existing protocols can be minimized, and the compatibility of technical solutions can be improved.

In the alternative examples based on FIG. 4 or FIG. 5, as shown in FIG. 9, the method further includes the following steps 602-610.

Step 602 includes sending a resume request to the network device by the user equipment in the Up-Link only RRC_INACTIVE.

In an example, the resume request is not only configured to request to switch the RRC state from the Up-Link only RRC_INACTIVE to the active state (or request to maintain at the Up-Link only RRC_INACTIVE), but also configured to enable the network device to determine an RNA where the user terminal is located.

Step 604 includes receiving, by the network device, the resume request sent by the user equipment.

As an alternative function or an additional function, the network device determines the RNA where the user terminal is located according to the resume request.

Step 606 includes sending a resume message to the user equipment by the network device.

Step 608 includes receiving, by the user equipment, the resume message sent by network device.

Step 610 includes switching the RRC state from the Up-Link only RRC_INACTIVE to the active state by the user equipment or maintaining at the Up-Link only RRC_INACTIVE by the user equipment, according to the resume message.

After receiving the resume message, the user equipment switches the RRC state from the Up-Link only RRC_INACTIVE to the active state or continues to maintain at the Up-Link only RRC_INACTIVE.

To sum up, according to the method provided by the example, the RRC state is switched from the Up-Link only RRC_INACTIVE to the active state by following the resume request, changes to existing protocols can be minimized, and the compatibility of technical solutions can be improved.

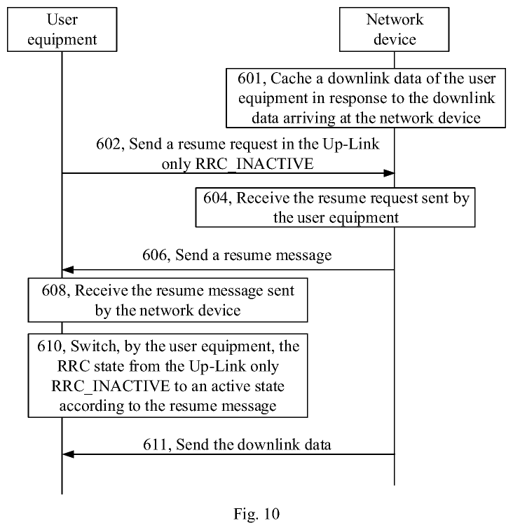

In the alternative examples based on FIG. 9, as shown in FIG. 10, the method further includes step 601 and step 611.

Step 601 includes caching downlink data of the user equipment by the network device in response to the downlink data arriving at the network device.

The network device caches the downlink data of the user equipment in response to the downlink data arriving at the network device and the user equipment being in the Up-Link only RRC_INACTIVE.

The downlink data includes at least one of downlink service data and the paging message.

Step 611 includes sending the downlink data to the user equipment by the network device.

The network device sends the downlink data to the user equipment in the case that the user equipment is in the active state.

To sum up, according to the method provided by the example, the paging message from the network device does not need to be monitored in the Up-Link only RRC_INACTIVE, and the power consumption of the user equipment is effectively reduced.

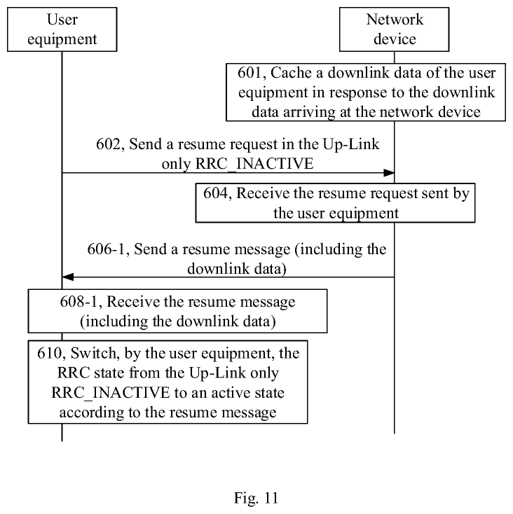

In the alternative examples based on FIG. 9, as shown in FIG. 11, the method further includes step 601, step 606 may be implemented as step 606-1, and step 608 may be implemented as step 608-1.

Step 601 includes caching downlink data of the user equipment by the network device in response to the downlink data arriving at the network device. Step 606-1 includes sending the resume message to the user equipment by the network device, and the resume message carries the cached downlink data. Step 608-1 includes receiving, by the user equipment, the resume message sent by the network device, and the resume message carries the cached downlink data.

In an example, after receiving the resume message, the user equipment switches the RRC state from the Up-Link only RRC_INACTIVE to the active state or continues to maintain at the Up-Link only RRC_INACTIVE.

To sum up, according to the method provided by the example, the paging message from the network device does not need to be monitored in the Up-Link only RRC_INACTIVE, and the power consumption of the user equipment is effectively reduced. Moreover, the downlink data is carried in the resume message, so that the user equipment can receive the downlink data as soon as possible.

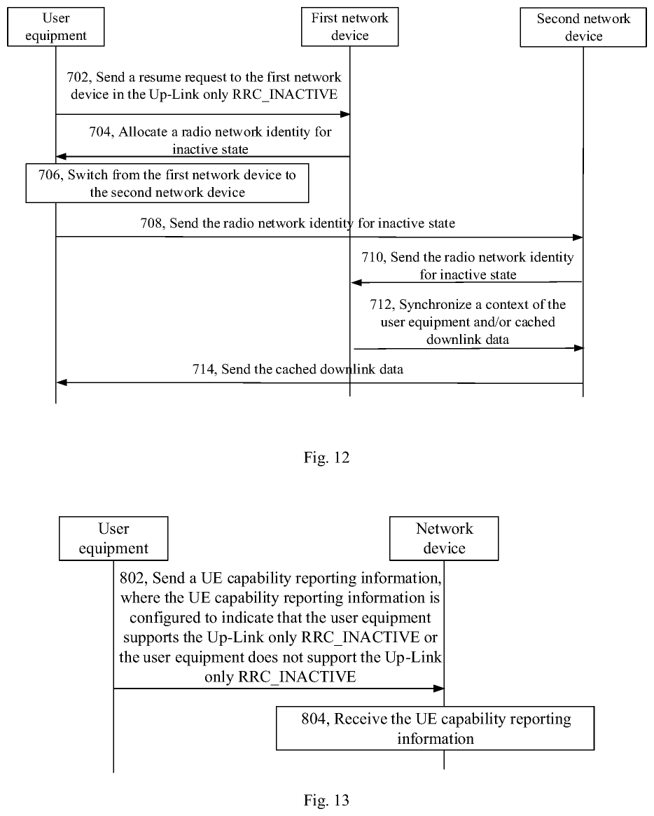

In the alternative examples based on FIG. 2 or FIG. 3, as shown in FIG. 12, the method further includes the following steps 702-714.

Step 702 includes sending a resume request to a first network device by the user equipment in the Up-Link only RRC_INACTIVE.

In the case that the user equipment is in the Up-Link only RRC_INACTIVE, the first network device caches the downlink data of the user equipment in response to the downlink data arriving at the first network device.

In an example, the first network device receives the resume request sent by the user equipment.

Step 704 includes receiving, by the user equipment, a radio network identity for inactive state allocated by the first network device, and the radio network identity for inactive state is configured for routing of the user equipment after the user equipment switches to a second network device.

In an example, the first network device allocates the radio network identity for inactive state to the user equipment. The radio network identity for inactive state is configured for routing of the user equipment after the user equipment switches to the second network device.

In an example, the radio network identity for inactive state is I-Radio Network Temporary Identity (I-RNTI). The first half of the I-RNTI is a base station identity (eNB ID) of the first network device, and the second half is a UE identity (UE ID) of the user equipment.

Step 706 includes switching from the first network device to the second network device by the user equipment.

Step 708 includes sending the radio network identity for inactive state to the second network device by the user equipment.

Step 710 includes sending the radio network identity for inactive state to the first network device by the second network device.

The first network device receives the radio network identity for inactive state sent by the second network device.

Step 712 includes synchronizing at least one of a context of the user equipment and the cached downlink data to the second network device by the first network device according to the radio network identity for inactive state.

In an example, the first network device synchronizes the context of the user equipment to the second network device according to the radio network identity for inactive state.

In an example, in the case that the first network device caches the downlink data of the user equipment, the first network device synchronizes the downlink data cached for the user equipment to the second network device according to the radio network identity for inactive state.

Finally, Step 714 includes sending the cached downlink data to the user equipment by the second network device.

In an example, after the user equipment switches the RRC state from the Up-Link only RRC_INACTIVE to the active state, the second network device sends the cached downlink data to the user equipment.

To sum up, according to the method provided by the example, by allocating the radio network identity for inactive state to the user equipment by the first network device, the user equipment can receive the downlink data cached by the first network device after switching to the second network device, and the reliability of the service is ensured.

In the alternative examples based on FIG. 2 or FIG. 3, as shown in FIG. 13, the method further includes the following steps 802 and 804.

Step 802 includes sending a UE capability reporting information to the network device by the user equipment, and the UE capability reporting information is configured to indicate that the user equipment supports the Up-Link only RRC_INACTIVE or the user equipment does not support the Up-Link only RRC_INACTIVE.

In an example, the network device sends a UE capability inquiry to the user equipment, and the user equipment sends the UE capability reporting information to the network device. One or more bits exist in the UE capability reporting information, which is configured to indicate that the user equipment supports the Up-Link only RRC_INACTIVE or the user equipment does not support the Up-Link only RRC_INACTIVE.

For example, a value of 1 for an information bit indicates that the user equipment supports the Up-Link only RRC_INACTIVE; and a value of 0 for the information bit indicates that the user equipment does not support the Up-Link only RRC_INACTIVE.

Step 804 includes receiving, by the network device, the UE capability reporting information sent by the user equipment.

In the case that the capability of the UE supports the Up-Link only RRC_INACTIVE, the network device configures the user equipment to set the RRC state as the Up-Link only RRC_INACTIVE.

To sum up, according to the method provided by the example, in the case that the capability of the UE supports the Up-Link only RRC_INACTIVE, the network device configures the user equipment to set the RRC state as the Up-Link only RRC_INACTIVE, so that compatibility for UEs of different capabilities are improved.

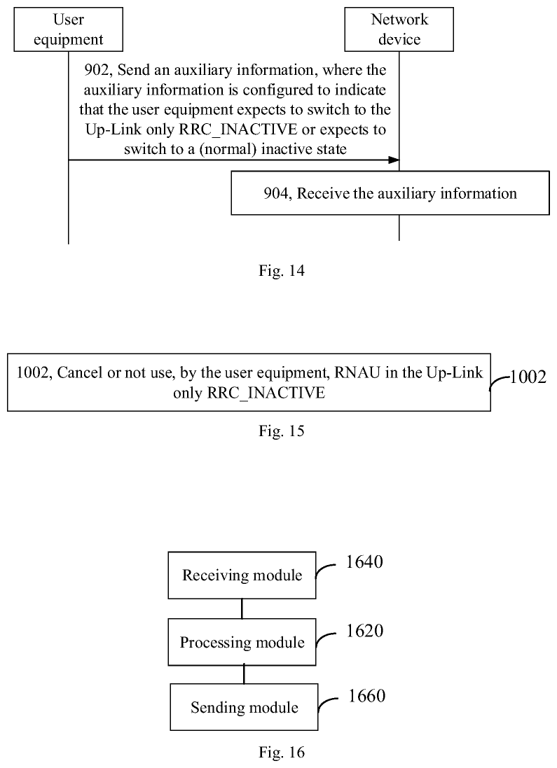

In the alternative examples based on FIG. 2 or FIG. 3, as shown in FIG. 14, the method further includes the following steps 902 and 904.

Step 902 includes sending an auxiliary information to the network device by the user equipment, where the auxiliary information is configured to indicate that the user terminal expects to switch to the Up-Link only RRC_INACTIVE or expects to switch to the normal inactive state.

Step 904 includes receiving, by the network device, the auxiliary information sent by the user equipment.

In the case that the user equipment expects to switch to the Up-Link only RRC_INACTIVE, the network device configures the user equipment to set the RRC state as the Up-Link only RRC_INACTIVE.

To sum up, according to the method provided by the example, in the case that the user equipment expects to switch to the Up-Link only RRC_INACTIVE, the network device configures the user equipment to set the RRC state as the Up-Link only RRC_INACTIVE, so that the requirements of the user equipment are better satisfied.

In the alternative examples based on FIG. 2 or FIG. 3, as shown in FIG. 15, the method further includes step 1002.

Step 1002 includes canceling or not using RNAU by the user equipment in the Up-Link only RRC_INACTIVE.

This step includes at least one of the following two modes.

In an example, the user equipment cancels or does not use periodic RNAU in the Up-Link only RRC_INACTIVE.

In an example, the user equipment cancels or does not use RNAU triggered by change of RAN notification area (RNA) in the Up-Link only RRC_INACTIVE.

“Cancel” in this step may be understood as ignore, or be unavailable, or not execute, or not use.

To sum up, according to the method provided by the example, the UE can better save the power consumption by canceling the RNAU.

It should be noted that the above-mentioned examples may also be freely combined and implemented by those skilled in the art, and each drawing or a part of steps in each drawing may also be implemented as a separate example, which is not limited in the disclosure.

FIG. 16 shows a block diagram of an apparatus for configuring RRC state according to an example of the disclosure. The apparatus may be implemented as user equipment, or implemented as a part of the user equipment, or applied in the user equipment. The apparatus includes: a processing module 1620, configured to set a radio resource control (RRC) state as Up-Link only RRC_INACTIVE according to configuration by a network device.

In one example, the Up-Link only RRC_INACTIVE is an RRC sub-state of an inactive state.

In one example, the Up-Link only RRC_INACTIVE is an RRC state operating independently of the inactive state.

In one example, the apparatus further includes: a sending module 1660, configured to send a resume request to the network device in the Up-Link only RRC_INACTIVE; a receiving module 1640, configured to receive a resume message sent by the network device; the receiving module 1640 is further configured to receive downlink data sent by the network device after switching the RRC state from the Up-Link only RRC_INACTIVE to an active state according to the resume message; and where the downlink data is data cached by the network device before receiving the resume request.

In one example, the apparatus further includes: the sending module 1660, configured to send a resume request to the network device in the Up-Link only RRC_INACTIVE; and the receiving module 1640, configured to receive a resume message sent by the network device, the resume message carrying downlink data; where the downlink data is data cached by the network device before receiving the resume request.

In one example, the processing module 1620 is further configured to cancel or not use RNAU in the Up-Link only RRC_INACTIVE.

In one example, the processing module 1620 is further configured to cancel or not use periodic RNAU in the Up-Link only RRC_INACTIVE.

In one example, the processing module 1620 is further configured to cancel or not use RNAU triggered by the change of RNA in the Up-Link only RRC_INACTIVE.

In one example, the apparatus further includes: the sending module 1660, configured to send a resume request to the network device, the resume request being configured to enable the network device to determine an RNA where the user equipment is located.

In one example, the apparatus further includes: the sending module 1660, configured to send a resume request to a first network device; and the receiving module 1640, configured to receive a radio network identity for inactive state allocated by the first network device, the radio network identity for inactive state being configured for routing of the user equipment after switching to a second network device.

In one example, the receiving module 1640 is further configured to receive downlink data sent by the second network device after switching to the second network device, and the downlink data is obtained by the second network device from the first network device according to the radio network identity for inactive state.

In one example, the receiving module 1640 is further configured to receive a first configuration signaling sent by the network device, and switch the RRC state from an inactive state to the Up-Link only RRC_INACTIVE according to the first configuration signaling.

In one example, the apparatus further includes: the receiving module 1640, further configured to receive a second configuration signaling sent by the network device; and the processing module 1620, further configured to switch the RRC state from the Up-Link only RRC_INACTIVE to the inactive state according to the second configuration signaling.

In one example, the first configuration signaling is an RRC message, a medium access control control element (MAC CE) or a downlink control information (DCI).

In one example, the second configuration signaling is an RRC message, a medium access control control element (MAC CE) or a downlink control information (DCI).

In one example, the receiving module 1640 is configured to receive a third configuration signaling sent by the network device; and the processing module 1620 is configured to switch the RRC state from an active state to the Up-Link only RRC_INACTIVE according to the third configuration signaling.

In one example, the third configuration signaling is an RRC connection release message.

In one example, the apparatus further includes: the receiving module 1640, configured to receive a fourth configuration signaling sent by the network device; and the processing module 1620, configured to switch the RRC state from the Up-Link only RRC_INACTIVE to an idle state according to the fourth configuration signaling; or the sending module 1660, configured to send a resume request to the network device; the receiving module 1640, configured to receive a resume message sent by the network device; and the processing module 1620, configured to switch the RRC state from the Up-Link only RRC_INACTIVE to the active state or maintain the RRC state at the Up-Link only RRC_INACTIVE according to the resume message.

In one example, the fourth configuration signaling is an RRC connection release message.

In one example, the apparatus further includes: the sending module 1660, configured to send a user equipment capability reporting information to the network device, the user equipment capability reporting information being configured to indicate that the user equipment supports the Up-Link only RRC_INACTIVE.

In one example, the apparatus further includes: the sending module 1660, configured to send an auxiliary information to the network device, the auxiliary information being configured to indicate that the user equipment expects to switch to the Up-Link only RRC_INACTIVE or expects to switch to the inactive state.

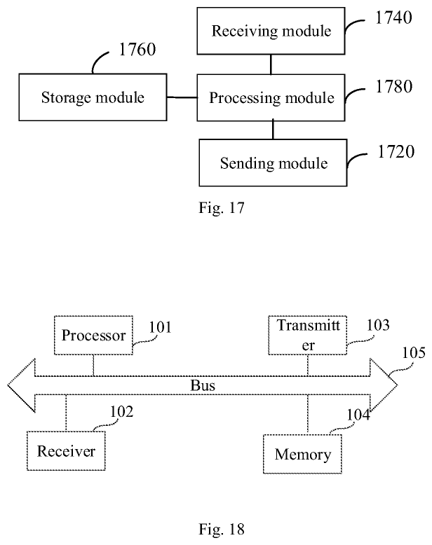

FIG. 17 shows a block diagram of an apparatus for configuring RRC state according to an example of the disclosure. The apparatus may be implemented as a network device, or implemented as a part of the network device, or applied in the network device. The apparatus includes: a sending module 1720, configured to configure a user equipment to set a radio resource control (RRC) state as Up-Link only RRC_INACTIVE.

In one example, the Up-Link only RRC_INACTIVE is an RRC sub-state of an inactive state.

In one example, the Up-Link only RRC_INACTIVE is an RRC state operating independently of the inactive state.

In one example, the apparatus further includes: a storage module 1760, configured to cache downlink data of the user equipment in response to the downlink data arriving at the network device; and a receiving module 1740, configured to receive a resume request of the user equipment. The sending module 1720 is configured to send a resume message to the user equipment, the resume message being configured to indicate the user equipment to switch the RRC state from the Up-Link only RRC_INACTIVE to the active state. Additionally, the sending module 1720 is configured to send the downlink data to the user equipment.

In one example, the apparatus further includes: a storage module 1760, configured to cache downlink data of the user equipment in response to the downlink data arriving at the network device; and the receiving module 1740, configured to receive a resume request of the user equipment. The sending module 1720 is configured to send a resume message to the user equipment, the resume message carrying the downlink data.

In one example, the apparatus further includes: the receiving module 1740, configured to receive a resume request of the user equipment; and a processing module 1780, configured to determine a RAN notification area (RNA) where the user equipment is located according to the resume request.

In one example, the apparatus further includes: the receiving module 1740, configured to receive a resume request of the user equipment; and the sending module 1720, configured to allocate a radio network identity for inactive state to the user equipment, the radio network identity for inactive state being configured for routing of the user equipment after switching to a second network device.

In one example, the apparatus further includes: the receiving module 1740, configured to receive the radio network identity for inactive state sent by the second network device; and the sending module 1720, configured to synchronize at least one of a context of the user equipment and cached downlink data to the second network device according to the radio network identity for inactive state.

In one example, the sending module 1720 is configured to send a first configuration signaling to the user equipment, and the first configuration signaling is configured to indicate the user equipment to switch the RRC state from the inactive state to the Up-Link only RRC_INACTIVE.

In one example, the sending module 1720 is configured to send a second configuration signaling to the user equipment, and the second configuration signaling is configured to indicate the user equipment to switch the RRC state from the Up-Link only RRC_INACTIVE to the inactive state.

In one example, the first configuration signaling is an RRC message, a medium access control control element (MAC CE) or a downlink control information (DCI).

In one example, the second configuration signaling is an RRC message, a medium access control control element (MAC CE) or a downlink control information (DCI).

In one example, the sending module 1720 is configured to send a third configuration signaling to the user equipment, and the third configuration signaling is configured to indicate the user equipment to switch the RRC state from the active state to the Up-Link only RRC_INACTIVE.

In one example, the third configuration signaling is an RRC connection release message.

In one example, the apparatus further includes: the sending module 1720, configured to send a fourth configuration signaling to the user equipment, and the fourth configuration signaling is configured to switch the RRC state from the Up-Link only RRC_INACTIVE to an idle state; or the receiving module 1740, configured to receive a resume request of the user equipment; and the sending module 1720, configured to send a resume message to the user equipment, the resume message being configured to indicate the user equipment to switch the RRC state from the Up-Link only RRC_INACTIVE to the active state or to maintain the RRC state at the Up-Link only RRC_INACTIVE.

In one example, the fourth configuration signaling is an RRC connection release message.

In one example, the apparatus further includes: the receiving module 1740, configured to receive a capability information sent by the user equipment, the capability information being configured to indicate that the user equipment supports the Up-Link only RRC_INACTIVE.

In one example, the capability information is carried in a user equipment capability reporting information.

In one example, the apparatus further includes: the receiving module 1740, configured to receive an auxiliary information sent by the user equipment, the auxiliary information being configured to indicate that the user equipment expects to switch to the Up-Link only RRC_INACTIVE or expects to switch to the inactive state.

FIG. 18 shows a schematic structural diagram of a communication device (that is, user equipment or network device) according to an example of the disclosure. The communication device includes a processor 101, a receiver 102, a transmitter 103, a memory 104 and a bus 105.

The processor 101 includes one or more processing cores, and the processor 101 executes various functional applications and information processing by running software programs and modules.

The receiver 102 and the transmitter 103 may be implemented as a communication component, which may be a communication chip.

The memory 104 is connected to the processor 101 through the bus 105.

The memory 104 may be configured to store at least one signaling, and the processor 101 may be configured to execute the at least one signaling, so as to implement various steps in the above examples of the method.

In addition, the memory 104 may be implemented by any type or combination of volatile or non-volatile storage devices including, but is not limited to, magnetic or optical disks, electrically Erasable Programmable Read Only Memory (EEPROM), Erasable Programmable Read Only Memory (EPROM), Static Random Access Memory (SRAM), Read-Only Memory (ROM), magnetic memory, flash memory, and Programmable Read-Only Memory (PROM).

In an example, there is further provided a computer-readable storage medium, the computer-readable storage medium stores at least one signaling, at least one piece of program, a code set or a signaling set, and the at least one signaling, the at least one piece of program, the code set or the signaling set is loaded and executed by a processor to implement the method for configuring RRC state executed by the communication device according to each of the above examples of the method.

Additional non-limiting embodiments of the disclosure include the following.

In one example, there is provided a method for configuring RRC state, including: setting, by a user equipment, a radio resource control (RRC) state as Up-Link only RRC_INACTIVE according to configuration by a network device.

In one example, the Up-Link only RRC_INACTIVE is an RRC sub-state of an inactive state.

In one example, the Up-Link only RRC_INACTIVE is an RRC state operating independently of an inactive state.

In one example, the method further includes: sending, by the user equipment, a resume request to the network device in the Up-Link only RRC_INACTIVE; receiving, by the user equipment, a resume message sent by the network device; and receiving, by the user equipment, downlink data sent by the network device after the user equipment switches the RRC state from the Up-Link only RRC_INACTIVE to an active state according to the resume message; wherein the downlink data is a downlink data cached by the network device before receiving the resume request.

In one example, the method further includes: sending, by the user equipment, a resume request to the network device in the Up-Link only RRC_INACTIVE; and receiving, by the user equipment, a resume message sent by the network device, and the resume message carrying a downlink data; wherein the downlink data is a downlink data cached by the network device before receiving the resume request.

In one example, the method further includes: canceling or not using, by the user equipment, RAN notification area update (RNAU) in the Up-Link only RRC_INACTIVE.

In one example, canceling, by the user equipment, the RAN notification area update (RNAU) in the Up-Link only RRC_INACTIVE, comprises: canceling or not using, by the user equipment, periodic RNAU in the Up-Link only RRC_INACTIVE.

In one example, canceling, by the user equipment, the RAN notification area update (RNAU) in the Up-Link only RRC_INACTIVE, comprises: canceling or not using, by the user equipment, RNAU triggered by change of RAN notification area (RNA) in the Up-Link only RRC_INACTIVE.

In one example, the method further includes: sending, by the user equipment, a resume request to the network device in the Up-Link only RRC_INACTIVE, and the resume request being configured to enable the network device to determine an RNA where the user equipment is located.

In one example, the method further includes: sending, by the user equipment, a resume request to a first network device in the Up-Link only RRC_INACTIVE; and receiving, by the user equipment, a radio network identity for inactive state allocated by the first network device, and the radio network identity for inactive state being configured for routing of the user equipment after switching to a second network device.

In one example, the method further includes: receiving, by the user equipment, a downlink data sent by the second network device after switching to the second network device, and the downlink data being a downlink data obtained by the second network device from the first network device according to the radio network identity for inactive state.

In one example, setting, by the user equipment, the radio resource control (RRC) state as the Up-Link only RRC_INACTIVE according to the configuration by the network device, comprises: receiving, by the user equipment, a first configuration signaling sent by the network device, and switching, by the user equipment, the RRC state from the inactive state to the Up-Link only RRC_INACTIVE according to the first configuration signaling.

In one example, the method further includes: receiving, by the user equipment, a second configuration signaling sent by the network device; and switching, by the user equipment, the RRC state from the Up-Link only RRC_INACTIVE to the inactive state according to the second configuration signaling.

In one example, the first configuration signaling is an RRC message, a medium access control control element (MAC CE) or a downlink control information (DCI).

In one example, the second configuration signaling is an RRC message, a medium access control control element (MAC CE) or a downlink control information (DCI).

In one example, setting, by the user equipment, the radio resource control (RRC) state as the Up-Link only RRC_INACTIVE according to the configuration by the network device, comprises: receiving, by the user equipment, a third configuration signaling sent by the network device, and switching, by the user equipment, the RRC state from an active state to the Up-Link only RRC_INACTIVE according to the third configuration signaling.

In one example, the third configuration signaling is an RRC connection release message.

In one example, the method further includes: receiving, by the user equipment, a fourth configuration signaling sent by the network device; and switching, by the user equipment, the RRC state from the Up-Link only RRC_INACTIVE to an idle state according to the fourth configuration signaling; or, sending, by the user equipment, a resume request to the network device; receiving, by the user equipment, a resume message sent by the network device; and switching, by the user equipment, the RRC state from the Up-Link only RRC_INACTIVE to an active state according to the resume message, or maintaining, by the user equipment, the RRC state at the Up-Link only RRC_INACTIVE according to the resume message.

In one example, the fourth configuration signaling is an RRC connection release message.

In one example, the method further includes: sending, by the user equipment, a user equipment capability reporting information to the network device, and the user equipment capability reporting information being configured to indicate that the user equipment supports the Up-Link only RRC_INACTIVE.

In one example, the method further includes: sending, by the user equipment, an auxiliary information to the network device, and the auxiliary information being configured to indicate that the user equipment expects to switch to the Up-Link only RRC_INACTIVE or expects to switch to an inactive state.

In one example, there is provided a method for configuring RRC state, comprising: configuring, by a network device, a user equipment to set a radio resource control (RRC) state as Up-Link only RRC_INACTIVE.

In one example, the Up-Link only RRC_INACTIVE is an RRC sub-state of an inactive state.

In one example, the Up-Link only RRC_INACTIVE is an RRC state operating independently of an inactive state.

In one example, the method further includes: caching, by the network device, a downlink data of the user equipment in response to the downlink data arriving at the network device; receiving, by the network device, a resume request of the user equipment; sending, by the network device, a resume message to the user equipment, and the resume message being configured to indicate the user equipment to switch the RRC state from the Up-Link only RRC_INACTIVE to an active state; and sending, by the network device, the downlink data to the user equipment.

In one example, the method further includes: caching, by the network device, a downlink data of the user equipment in response to the downlink data arriving at the network device; receiving, by the network device, a resume request of the user equipment; and sending, by the network device, a resume message to the user equipment, and the resume message carrying the downlink data.

In one example, the method further includes: receiving, by the network device, a resume request of the user equipment; and determining, by the network device, a RAN notification area (RAN) where the user equipment is located according to the resume request.

In one example, the method further includes: receiving, by the network device, a resume request of the user equipment; and allocating, by the network device, a radio network identity for inactive state to the user equipment, and the radio network identity for inactive state being configured for routing of the user equipment after switching to a second network device.

In one example, the method further includes: receiving, by the network device, the radio network identity for inactive state sent by the second network device, and synchronizing at least one of a context of the user equipment and cached downlink data to the second network device according to the radio network identity for inactive state.

In one example, configuring, by the network device, the user equipment to set the radio resource control (RRC) state as the Up-Link only RRC_INACTIVE, comprises: sending, by the network device, a first configuration signaling to the user equipment, and the first configuration signaling being configured to indicate the user equipment to switch the RRC state from the inactive state to the Up-Link only RRC_INACTIVE.

In one example, the method further includes: sending, by the network device, a second configuration signaling to the user equipment, and the second configuration signaling being configured to indicate the user equipment to switch the RRC state from the Up-Link only RRC_INACTIVE to the inactive state.

In one example, the first configuration signaling is an RRC message, a medium access control control element (MAC CE) or a downlink control information (DCI).

In one example, the second configuration signaling is an RRC message, a medium access control control element (MAC CE) or a downlink control information (DCI).

In one example, configuring, by the network device, the user equipment to set the radio resource control (RRC) state as the Up-Link only RRC_INACTIVE, comprises: sending, by the network device, a third configuration signaling to the user equipment, and the third configuration signaling being configured to indicate the user equipment to switch the RRC state from an active state to the Up-Link only RRC_INACTIVE.

In one example, the third configuration signaling is an RRC connection release message.

In one example, the method further includes: sending, by the network device, a fourth configuration signaling to the user equipment, and the fourth configuration signaling being configured to switch the RRC state from the Up-Link only RRC_INACTIVE to an idle state;

or, receiving, by the network device, a resume request of the user equipment; and sending, by the network device, a resume message to the user equipment, and the resume message being configured to indicate the user equipment to switch the RRC state from the Up-Link only RRC_INACTIVE to an active state or to maintain the RRC state at the Up-Link only RRC_INACTIVE.

In one example, the fourth configuration signaling is an RRC connection release message.

In one example, the method further includes: receiving, by the network device, a capability information sent by the user equipment, and the capability information being configured to indicate that the user equipment supports the Up-Link only RRC_INACTIVE.

In one example, the capability information is carried in a user equipment capability reporting information.

In one example, the method further includes: receiving, by the network device, an auxiliary information sent by the user equipment, and the auxiliary information being configured to indicate that the user equipment expects to switch to the Up-Link only RRC_INACTIVE or expects to switch to an inactive state.

In one example, there is provided an apparatus for configuring RRC state, comprising: a processing module, configured to set a radio resource control (RRC) state as Up-Link only RRC_INACTIVE according to configuration by a network device.

In one example, the Up-Link only RRC_INACTIVE is an RRC sub-state of an inactive state.

In one example, the Up-Link only RRC_INACTIVE is an RRC state operating independently of an inactive state.

In one example, the apparatus further includes: a sending module, configured to send a resume request to the network device in the Up-Link only RRC_INACTIVE; and a receiving module, configured to receive a resume message sent by the network device; the receiving module is further configured to receive a downlink data sent by the network device after switching the RRC state from the Up-Link only RRC_INACTIVE to an active state according to the resume message; wherein the downlink data is a downlink data cached by the network device before receiving the resume request.

In one example, the apparatus further includes: a sending module, configured to send a resume request to the network device in the Up-Link only RRC_INACTIVE; and a receiving module, configured to receive a resume message sent by the network device, and the resume message carrying a downlink data; wherein the downlink data is a downlink data cached by the network device before receiving the resume request.

In one example, the processing module is further configured to cancel or not use RAN notification area update (RNAU) in the Up-Link only RRC_INACTIVE.

In one example, the processing module is further configured to cancel or not use periodic RNAU in the Up-Link only RRC_INACTIVE.

In one example, the processing module is further configured to cancel or not use RNAU triggered by change of RAN notification area (RNA) in the Up-Link only RRC_INACTIVE.

In one example, the apparatus further includes: a sending module, configured to send a resume request to the network device, and the resume request being configured to enable the network device to determine an RNA where the user equipment is located.

In one example, the apparatus further includes: a sending module, configured to send a resume request to a first network device; and a receiving module, configured to receive a radio network identity for inactive state allocated by the first network device, and the radio network identity for inactive state being configured for routing of the user equipment after switching to a second network device.

In one example, the receiving module is further configured to receive a downlink data sent by the second network device after switching to the second network device, and the downlink data being a downlink data obtained by the second network device from the first network device according to the radio network identity for inactive state.

In one example, the receiving module is further configured to receive a first configuration signaling sent by the network device, and switch the RRC state from the inactive state to the Up-Link only RRC_INACTIVE according to the first configuration signaling.

In one example, the apparatus further includes: the receiving module, further configured to receive a second configuration signaling sent by the network device; and the processing module, further configured to switch the RRC state from the Up-Link only RRC_INACTIVE to the inactive state according to the second configuration signaling.

In one example, the first configuration signaling is an RRC message, a medium access control control element (MAC CE) or a downlink control information (DCI).

In one example, the second configuration signaling is an RRC message, a medium access control control element (MAC CE) or a downlink control information (DCI).

In one example, the receiving module is configured to receive a third configuration signaling sent by the network device; and the processing module is configured to switch the RRC state from an active state to the Up-Link only RRC_INACTIVE according to the third configuration signaling.

In one example, the third configuration signaling is an RRC connection release message.

In one example, the apparatus further includes: a receiving module, configured to receive a fourth configuration signaling sent by the network device, and the processing module, configured to switch the RRC state from the Up-Link only RRC_INACTIVE to an idle state according to the fourth configuration signaling; or, a sending module, configured to send a resume request to the network device; the receiving module, configured to receive a resume message sent by the network device; and the processing module, configured to switch the RRC state from the Up-Link only RRC_INACTIVE to an active state or to maintain the RRC state at the Up-Link only RRC_INACTIVE according to the resume message.

In one example, the fourth configuration signaling is an RRC connection release message.

In one example, the apparatus further includes: the sending module, configured to send a user equipment capability reporting information to the network device, and the user equipment capability reporting information being configured to indicate that the user equipment supports the Up-Link only RRC_INACTIVE.

In one example, the apparatus further includes: the sending module, configured to send an auxiliary information to the network device, and the auxiliary information being configured to indicate that the user equipment expects to switch to the Up-Link only RRC_INACTIVE or expects to switch to an inactive state.

In one example, the apparatus further includes: a sending module, configured to configure a user equipment to set a radio resource control (RRC) state as Up-Link only RRC_INACTIVE.

In one example, the Up-Link only RRC_INACTIVE is an RRC sub-state of an inactive state.

In one example, the Up-Link only RRC_INACTIVE is an RRC state operating independently of an inactive state.

In one example, the apparatus further includes: a storage module, configured to cache a downlink data of the user equipment in response to the downlink data arriving at the network device; a receiving module, configured to receive a resume request of the user equipment; the sending module is configured to send a resume message to the user equipment, and the resume message being configured to indicate the user equipment to switch the RRC state from the Up-Link only RRC_INACTIVE to an active state; and the sending module is configured to send the downlink data to the user equipment.

In one example, the apparatus further includes: a storage module, configured to cache a downlink data of the user equipment in response to the downlink data arriving at the network device; a receiving module, configured to receive a resume request of the user equipment; and the sending module, configured to send a resume message to the user equipment, and the resume message carrying the downlink data.

In one example, the apparatus further includes: a receiving module, configured to receive a resume request of the user equipment; and a processing module, configured to determine a RAN notification area (RAN) where the user equipment is located according to the resume request.

In one example, the apparatus further includes: a receiving module, configured to receive a resume request of the user equipment; and the sending module, configured to allocate a radio network identity for inactive state to the user equipment, and the radio network identity for inactive state being configured for routing of the user equipment after switching to a second network device.

In one example, the apparatus further includes: the receiving module, configured to receive the radio network identity for inactive state sent by the second network device; and the sending module, configured to synchronize at least one of a context of the user equipment and cached downlink data to the second network device according to the radio network identity for inactive state.

In one example, the sending module is configured to send a first configuration signaling to the user equipment, and the first configuration signaling being configured to indicate the user equipment to switch the RRC state from the inactive state to the Up-Link only RRC_INACTIVE.

In one example, the sending module is configured to send a second configuration signaling to the user equipment, and the second configuration signaling being configured to indicate the user equipment to switch the RRC state from the Up-Link only RRC_INACTIVE to the inactive state.

In one example, the first configuration signaling is an RRC message, a medium access control control element (MAC CE) or a downlink control information (DCI).

In one example, the second configuration signaling is an RRC message, a medium access control control element (MAC CE) or a downlink control information (DCI).

In one example, the sending module is configured to send a third configuration signaling to the user equipment, and the third configuration signaling being configured to indicate the user equipment to switch the RRC state from an active state to the Up-Link only RRC_INACTIVE.

In one example, the third configuration signaling is an RRC connection release message.

In one example, the apparatus further includes: the sending module, configured to send a fourth configuration signaling to the user equipment, and the fourth configuration signaling being configured to switch the RRC state from the Up-Link only RRC_INACTIVE to an idle state; or, a receiving module, configured to receive a resume request of the user equipment; and the sending module, configured to send a resume message to the user equipment, and the resume message being configured to indicate the user equipment to switch the RRC state from the Up-Link only RRC_INACTIVE to an active state or to maintain the RRC state at the Up-Link only RRC_INACTIVE.

In one example, the fourth configuration signaling is an RRC connection release message.

In one example, the apparatus further includes: the receiving module, configured to receive a capability information sent by the user equipment, and the capability information being configured to indicate that the user equipment supports the Up-Link only RRC_INACTIVE.

In one example, the capability information is carried in a user equipment capability reporting information.

In one example, the apparatus further includes: the receiving module, configured to receive an auxiliary information sent by the user equipment, and the auxiliary information being configured to indicate that the user equipment expects to switch to the Up-Link only RRC_INACTIVE or expects to switch to an inactive state.

Those ordinarily skilled in the art may understand that all or part of the steps of implementing the above examples can be accomplished by hardware, or can be accomplished by signaling related hardware through a program, and the program may be stored in a computer-readable storage medium. The storage medium mentioned above may be a read-only memory, a magnetic disk or an optical disk, etc.

The above is only alternative examples of the disclosure and are not used to limit the disclosure, and any modification, equivalent replacement, improvement, etc. made within the spirit and principle of the disclosure should be included in the scope of protection of the disclosure.

1. A method for configuring RRC state, comprising:
setting, by a user equipment, a radio resource control (RRC) state as Up-Link only RRC_INACTIVE according to configuration by a network device.

2-3. (canceled)

4. The method according to claim 1, further comprising:
sending, by the user equipment, a resume request to the network device in the Up-Link only RRC_INACTIVE;
receiving, by the user equipment, a resume message sent by the network device; and
receiving, by the user equipment, downlink data sent by the network device after the user equipment switches the RRC state from the Up-Link only RRC_INACTIVE to an active state according to the resume message, and
wherein the downlink data is a downlink data cached by the network device before receiving the resume request; or
the method further comprises:
sending, by the user equipment, a the resume request to the network device in the Up-Link only RRC_INACTIVE; and
receiving, by the user equipment, a the resume message sent by the network device, wherein the resume message carries a the downlink data, and;
wherein the downlink data is a downlink data cached by the network device before receiving the resume request.

5. (canceled)

6. The method according to claim 1, further comprising:
canceling or not using, by the user equipment, RAN notification area update (RNAU) in the Up-Link only RRC_INACTIVE; or
sending, by the user equipment, a resume request to the network device in the Up-Link only RRC_INACTIVE, and the resume request being configured to enable the network device to determine an RNA where the user equipment is located.

7-9. (canceled)

10. The method according to claim 1, further comprising:
sending, by the user equipment, a resume request to a first network device in the Up-Link only RRC_INACTIVE; and
receiving, by the user equipment, a radio network identity for inactive state allocated by the first network device, and the radio network identity for inactive state being configured for routing of the user equipment after switching to a second network device.

11. The method according to claim 10, further comprising:
receiving, by the user equipment, a downlink data sent by the second network device after switching to the second network device, and the downlink data being a downlink data obtained by the second network device from the first network device according to the radio network identity for inactive state.

12. The method according to claim 1, wherein
setting, by the user equipment, the radio resource control (RRC) state as the Up-Link only RRC_INACTIVE according to the configuration by the network device, comprises: receiving, by the user equipment, a first configuration signaling sent by the network device, and switching, by the user equipment, the RRC state from the inactive state to the Up-Link only RRC_INACTIVE according to the first configuration signaling; or
setting, by the user equipment, the (RRC) state as the Up-Link only RRC_INACTIVE according to the configuration by the network device, comprises: receiving, by the user equipment, a third configuration signaling sent by the network device, and switching, by the user equipment, the RRC state from an active state to the Up-Link only RRC_INACTIVE according to the third configuration signaling.

13. The method according to claim 12, further comprising:
receiving, by the user equipment, a second configuration signaling sent by the network device; and
switching, by the user equipment, the RRC state from the Up-Link only RRC_INACTIVE to the inactive state according to the second configuration signaling.

14-17. (canceled)

18. The method according to claim 1, further comprising: receiving, by the user equipment, a fourth configuration signaling sent by the network device; and switching, by the user equipment, the RRC state from the Up-Link only RRC_INACTIVE to an idle state according to the fourth configuration signaling; or, sending, by the user equipment, a resume request to the network device; receiving, by the user equipment, a resume message sent by the network device; and switching, by the user equipment, the RRC state from the Up-Link only RRC_INACTIVE to an active state according to the resume message, or maintaining, by the user equipment, the RRC state at the Up-Link only RRC_INACTIVE according to the resume message;
or
the method further comprises: sending, by the user equipment, a user equipment capability reporting information to the network device, and the user equipment capability reporting information being configured to indicate that the user equipment supports the Up-Link only RRC_INACTIVE;
or
the method further comprises: sending, by the user equipment, an auxiliary information to the network device, and the auxiliary information being configured to indicate that the user equipment expects to switch to the Up-Link only RRC_INACTIVE or expects to switch to an inactive state.

19-21. (canceled)

22. A method for configuring RRC state, comprising:
configuring, by a network device, a user equipment to set a radio resource control (RRC) state as Up-Link only RRC_INACTIVE.

23-24. (canceled)

25. The method according to claim 22, further comprising:
caching, by the network device, a downlink data of the user equipment in response to the downlink data arriving at the network device;
receiving, by the network device, a resume request of the user equipment; sending, by the network device, a resume message to the user equipment, and the resume message being configured to indicate the user equipment to switch the RRC state from the Up-Link only RRC_INACTIVE to an active state; and
sending, by the network device, the downlink data to the user equipment;
or
the method further comprises:
caching, by the network device, a downlink data of the user equipment in response to the downlink data arriving at the network device;
receiving, by the network device, a resume request of the user equipment; and
sending, by the network device, a resume message to the user equipment, and the resume message carrying the downlink data.

26. (canceled)

27. The method according to claim 22, further comprising:
receiving, by the network device, a resume request of the user equipment; and
determining, by the network device, a RAN notification area (RNA) where the user equipment is located according to the resume request.

28. The method according to claim 22, further comprising:
receiving, by the network device, a resume request of the user equipment; and
allocating, by the network device, a radio network identity for inactive state to the user equipment, and the radio network identity for inactive state being configured for routing of the user equipment after switching to a second network device.

29. The method according to claim 28, further comprising: receiving, by the network device, the radio network identity for inactive state sent by the second network device, and synchronizing at least one of a context of the user equipment and cached downlink data to the second network device according to the radio network identity for inactive state.

30. The method according to claim 22, wherein
configuring, by the network device, the user equipment to set the radio resource control (RRC) state as the Up-Link only RRC_INACTIVE, comprises: sending, by the network device, a first configuration signaling to the user equipment, and the first configuration signaling being configured to indicate the user equipment to switch the RRC state from the inactive state to the Up-Link only RRC_INACTIVE; or
configuring, by the network device, the user equipment to set the radio resource control (RRC) state as the Up-Link only RRC_INACTIVE, comprises: sending, by the network device, a third configuration signaling to the user equipment, and the third configuration signaling being configured to indicate the user equipment to switch the RRC state from an active state to the Up-Link only RRC_INACTIVE;
or
the method further comprises: sending, by the network device, a second configuration signaling to the user equipment, and the second configuration signaling being configured to indicate the user equipment to switch the RRC state from the Up-Link only RRC_INACTIVE to the inactive state.

31-35. (canceled)

36. The method according to claim 22, further comprising:
sending, by the network device, a fourth configuration signaling to the user equipment, and the fourth configuration signaling being configured to switch the RRC state from the Up-Link only RRC_INACTIVE to an idle state;
or,
receiving, by the network device, a resume request of the user equipment; and sending, by the network device, a resume message to the user equipment, and the resume message being configured to indicate the user equipment to switch the RRC state from the Up-Link only RRC_INACTIVE to an active state or to maintain the RRC state at the Up-Link only RRC_INACTIVE.

37. (canceled)

38. The method according to claim 22, further comprising:
receiving, by the network device, a capability information sent by the user equipment, and the capability information being configured to indicate that the user equipment supports the Up-Link only RRC_INACTIVE; or
receiving, by the network device, an auxiliary information sent by the user equipment, and the auxiliary information being configured to indicate that the user equipment expects to switch to the Up-Link only RRC_INACTIVE or expects to switch to an inactive state.

39-80. (canceled)

81. A User equipment, comprising:
a processor;
a transceiver connected with the processor; and
a memory configured to store an executable signaling executed by the processor;
wherein the processor is configured to load and execute the executable signaling to set a radio resource control (RRC) state as Up-Link only RRC_INACTIVE according to configuration by a network device.

82. A network device, comprising:
a processor;
a transceiver connected with the processor; and
a memory configured to store an executable signaling executed by the processor;
wherein the processor is configured to load and execute the executable signaling to implement the method for configuring RRC state according to claim 22.

83. A non-transitory computer-readable storage medium storing an executable signaling, and the executable signaling is loaded and executed by a processor to implement the method for configuring RRC state according to claim 1.

84. A non-transitory computer-readable storage medium storing an executable signaling, and the executable signaling is loaded and executed by a processor to implement the method for configuring RRC state according to claim 22.
